(19) United States
(12) Patent Application Publication
(10) Pub. No.: US 2015/0208207 A1
(43) Pub. Date: Jul. 23, 2015

(54) WIRELESS DEVICE LOCALIZATION

(71) Applicant: Lear Corporation, Southfield, MI (US)

(72) Inventors: Jian Ye, Troy, MI (US); Thomas O'Brien, Troy, MI (US); Jason Bauman, Birmingham, MI (US)

(21) Appl. No.: 14/598,102

(22) Filed: Jan. 15, 2015

Related U.S. Application Data
(60) Provisional application No. 61/930,274, filed on Jan. 22, 2014.

(51) Int. Cl. H04W 4/04

(52) U.S. Cl. CPC H04W 4/046

(57) ABSTRACT

A vehicle system is provided with a portable device configured to provide a wireless signal and at least three base stations for being positioned about a vehicle. Each base station being configured to receive the wireless signal and to generate a message indicative of a time of flight of the wireless signal. The vehicle system also includes a main base station for being positioned within the vehicle and configured to determine a general location of the portable device within one of a plurality of zones about the vehicle and to determine a three-dimensional location of the portable device based on the message using a first estimation in response to the portable device being located in a first zone.

### CROSS-REFERENCE TO RELATED APPLICATIONS

This application claims the benefit of U.S. provisional application Ser. No. 61/930,274 filed Jan. 22, 2014, the disclosure of which is hereby incorporated in its entirety by reference herein.

### TECHNICAL FIELD

One or more embodiments relate to a vehicle system and method for determining a location of a wireless device about a vehicle.

### BACKGROUND

Many modern vehicles are equipped one or more transceivers for communicating with a key fob using radio signals for controlling vehicle functions, such as passive keyless entry and passive starting. With passive entry, a vehicle controller determines which door to unlock based on the location of the key fob with respect to the vehicle. Such passive keyless entry systems often include up to six low frequency (LF) antennas. Each LF antenna is mounted proximate to a vehicle door (e.g., within the handle) and communicates with the key fob to determine its location. With passive start, a vehicle controller determines whether the driver is inside the vehicle or outside the vehicle based on the fob location. Such passive start systems often include at least one antenna inside of the vehicle, and another antenna externally mounted to the vehicle, (e.g., on the roof). Thus a vehicle equipped with a passive entry/passive start (PEPS) system may have up to eight antennas.

### SUMMARY

In one embodiment a vehicle system is provided with a portable device configured to provide a wireless signal and at least three base stations for being positioned about a vehicle. Each base station being configured to receive the wireless signal and to generate a message indicative of a time of flight of the wireless signal. The vehicle system also includes a main base station for being positioned within the vehicle and configured to determine a general location of the portable device within one of a plurality of zones about the vehicle and to determine a three-dimensional location of the portable device based on the message using a first estimation in response to the portable device being located in a first zone.

In another embodiment a vehicle system is provided with at least two base stations and a main base station for being positioned about a vehicle. Each base station being configured to receive a wireless signal from a portable device and to generate a message indicative of a time of flight of the wireless signal. The main base station being configured to determine a general location of the portable device within one of a plurality of zones about the vehicle and to determine a three-dimensional location of the portable device based on the message using a first estimation in response to the portable device being located in a first zone.

In yet another embodiment a vehicle system is provided with a portable device configured to provide a wireless signal, at least two base stations and a main base station. The at least two base stations being positioned about a vehicle and each base station being configured to receive the wireless signal and to generate a message indicative of a time of flight of the wireless signal. The main base station being positioned within the vehicle and configured to determine a general location of the portable device within one of a plurality of zones about the vehicle; determine a location of the portable device based on the message using a first estimation in response to the portable device being located in a first zone within the vehicle; and to determine the location of the portable device using a second estimation in response to the portable device being located in a second zone.

### BRIEF DESCRIPTION OF THE DRAWINGS

FIG. 1 is a schematic view of a vehicle with a vehicle system for detecting a location of a wireless device according to one or more embodiments;

FIG. 2 is a detailed schematic view of the wireless device, a main base station and an auxiliary base station according to one or more embodiments;

FIG. 3 is a simplified diagram of the vehicle and vehicle system of FIG. 1, illustrating coverage zones about the vehicle; and

FIG. 4 is a flow chart illustrating a method for determining a location of the wireless device according to one or more embodiments.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, RAM, ROM, EPROM, EEPROM, or other suitable variants thereof) and software which co-act with one another to perform any number of the operation(s) as disclosed herein.

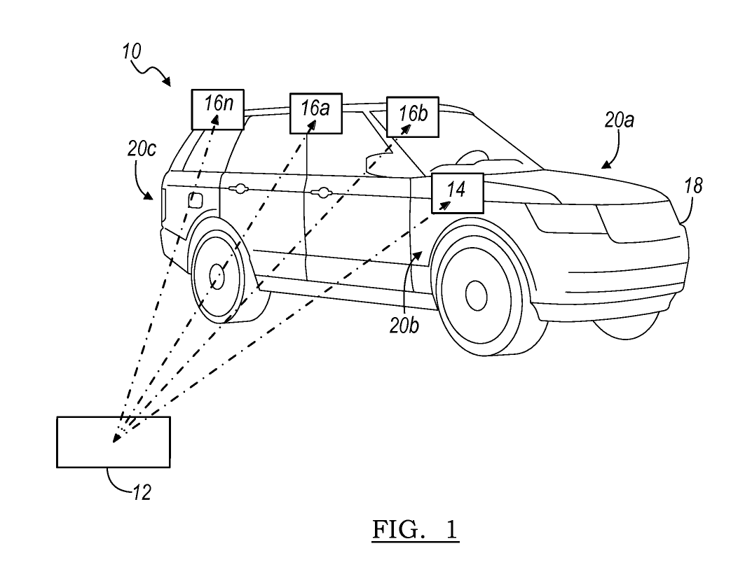

Referring to FIG. 1, a vehicle system for determining a location of a wireless device is illustrated in accordance with one or more embodiments and is generally referenced by numeral 10. The vehicle system 10 includes a portable wireless device 12 (e.g., a key fob) and at least four nodes, including a main base station 14 and at least three auxiliary base stations 16a, 16b, 16n (“16”). According to the illustrated embodiment, the three auxiliary base stations 16 are located within an upper portion of the vehicle (e.g. within a headliner). The main base station 14 is vertically spaced apart from the auxiliary base stations 16 and located in an intermediate portion of the vehicle (e.g. within a dashboard). The vertical spacing of the main base station 14 relative to the auxiliary base stations 16 allows the vehicle system 10 to determine the position of the wireless device 12 in three dimensions.

The main base station 14, the auxiliary base stations 16, and the wireless device 12 engage in a series of signal exchanges with one another and utilize a time of flight (TOF) implementation to determine a distance of the wireless device 12 relative to the vehicle 18. Thereafter, the main base station 14 estimates the position (x, y, z) of the wireless device 12. The use of such estimation enables the main base station 14 to locate where the wireless device 12 is positioned horizontally from the vehicle. The vertical offset between the main base station 14 and the auxiliary base stations 16a, 16b, 16n enables the vehicle system 10 to calculate a three-dimensional (3-D) location of the wireless device 12 relative to multiple planes. Such 3-D analysis provides for a more accurate location determination, than 2-D analysis relative to a single plane. This information (e.g., which zone 20 the wireless device 12 is positioned within) coupled with distance information as ascertained by utilizing TOF enables the main base station 14 to locate with increased levels of accuracy the location of the wireless device 12 in relation to the vehicle 18.

For example, the main base station 14 may determine that the wireless device 12 is positioned at a distance of three meters away from the vehicle 18 and that the wireless device 12 is positioned in the driver side zone 20a. While it is noted that the location of the wireless device 12 may be ascertained via TOF, it is recognized that the aspects noted herein with respect to locating the wireless device 12 may be applicable to other vehicle functions such as, but not limited to, tire pressure monitoring. While utilizing the TOF, it is recognized that the main base station 14 and the auxiliary base stations 16 may be positioned at predetermined locations in the vehicle 18 for transmitting and receiving signals to and from the wireless device 12.

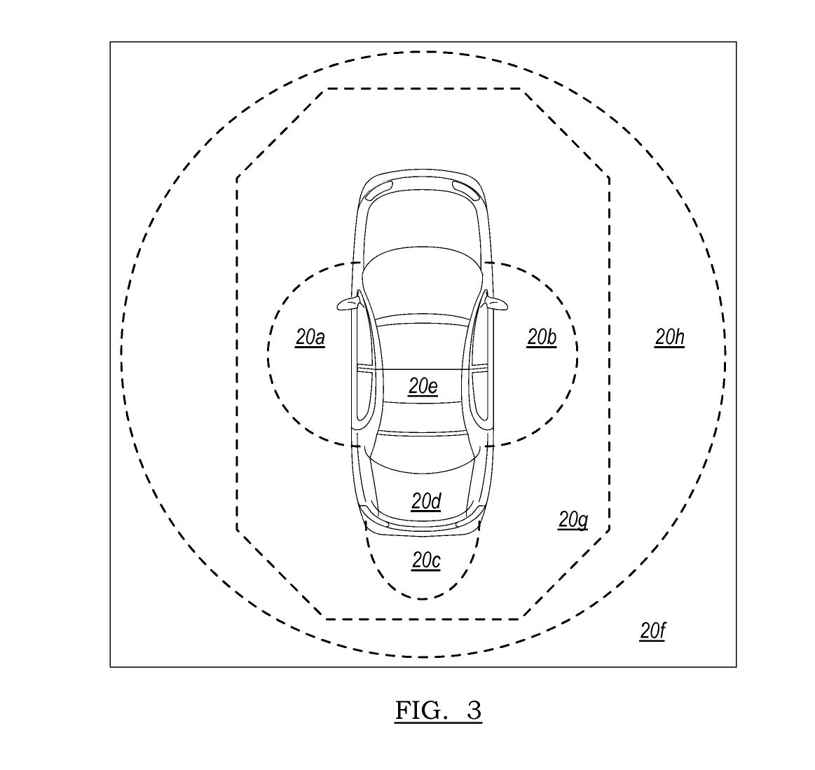

The main base station 14 generally includes additional circuitry to lock and unlock the vehicle 18 in response to command signals as provided by the wireless device 12. The vehicle system 10 performs a passive entry passive start (PEPS) function in which the main base station 14 unlocks the vehicle 18 in response to determining that the wireless device 12 is positioned in a corresponding zone 20a-20c (“20”) about the vehicle. For example, the illustrated embodiment depicts a driver side zone 20a, a passenger side zone 20b and a vehicle rear zone 20c. The zones 20 generally correspond to predetermined authorized locations about the vehicle 18 (e.g., interior to and exterior to the vehicle 18) such that if the wireless device 12 is detected to be in one of such zones 20, then the main base station 14 may automatically unlock the vehicle (or door) proximate to the zone 20 in which the wireless device 12 is detected to be within and enable the user to start the vehicle. The zones 20 are further described below with reference to FIG. 3.

The vehicle system 10 utilizes remote keyless operation in addition to the PEPS function, according to one or more embodiments. For example, the main base station 14 may perform a desired operation (e.g., lock, unlock, lift gate release, etc.) with the vehicle 18 in the event the wireless device 12 transmits a command indicative of the desired operation while within the authorized zone 20.

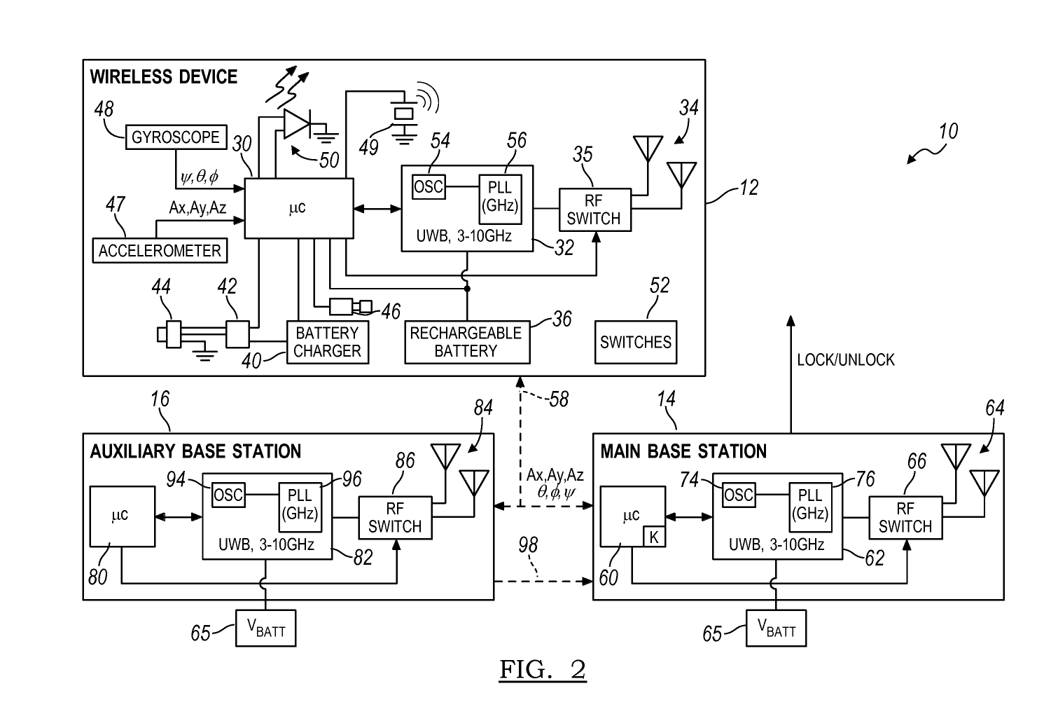

FIG. 2 depicts a detailed schematic view of the wireless device 12, the main base station 14, and the auxiliary base station(s) 16 in accordance with one or more embodiments. The wireless device 12 includes a microcontroller 30, a transmitter/receiver (“transceiver”) 32, and at least one antenna 34. The microcontroller 30 is operably coupled to the transceiver 32 and the antenna 34 for transmitting and receiving signals to/from the main base station 14 and the auxiliary base stations 16. A radio frequency (RF) switch 35 is operably coupled to the antennas 34 for coupling the same to the transceiver 32. A multiple antenna 34 implementation may provide for antenna diversity which may aid with respect to radio frequency multi-paths. The use of the RF switch 35 and multiple antennas are optional. For example, a single antenna 34 may be used for transmitting and receiving signals to and from the wireless device 12.

The wireless device 12 includes a rechargeable battery 36 that powers the microcontroller 30 and the transceiver 32 according to one or more embodiments. A battery charger circuit 40 receives power from a charger connector 42 that is operably coupled to an external power supply (not shown). The microcontroller 30 may control a first lighting indicator 44 and/or a vibrating motor 46 to provide feedback to the user that is indicative of the state of charge of the battery 36. The wireless device 12 may also include an accelerometer 47 and a gyroscope 48 for detecting the motion of the wireless device 12 for providing wake-up functionality. The accelerometer 47 may provide data that is indicative of the acceleration of the wireless device 12 in three axis (Aₓ, A_{y}, and A_{z}). The gyroscope 48 may provide orientation data that is indicative of a yaw rate (Ψ), a pitch rate (θ), and a roll rate (φ) of the wireless device 12. In other embodiments, the wireless device 12 includes a tilt sensor (not shown) for providing wake-up functionality. Further, a piezo-sounder 49 and a second lighting indicator may also be operably coupled to the microcontroller 30 for providing additional feedback. A plurality of switches 52 are positioned on the wireless device 12 for transmitting commands to the vehicle 18 for initiating a number of vehicle operations (e.g., door lock and unlock, lift gate release, remote start, etc.).

The transceiver 32 is generally configured to operate at a frequency of between 3 and 10 GHz and communicate within an ultra-wide band (UWB) bandwidth of at least 500 MHz. Such high frequency communication in the UWB bandwidth enables the vehicle system 10 to determine a distance of the wireless device 12 with respect to the vehicle within a high degree of accuracy. The transceiver 32 generally includes an oscillator 54 and a phase locked loop (PLL) 56 for enabling the transceiver 32 to operate at the frequency of between 3 and 10 GHz.

The microcontroller 30 is operably coupled to the transceiver 32 and the antenna 34 for transmitting a wireless signal 58 to the main base station 14 and each auxiliary base station 16. The wireless signal 58 includes data such as encryption data, the acceleration data (Aₓ, A_{y}, and A_{z}), and the gyroscope data (Ψ, θ, and φ), according to one or more embodiments.

The main base station 14 generally includes a microcontroller 60, a transceiver 62, and at least one antenna 64. A power source 65 in the vehicle 18 powers the microcontroller 60 and the transceiver 62. An RF switch 66 is operably coupled to the microcontroller 60 and to the antenna 64. The RF switch 66 is operably coupled to the antennas 64 for coupling the same to the transceiver 62. A multiple antenna 64 implementation may provide for antenna diversity which may aid with respect to RF multi-paths. It is also contemplated that a single antenna 64 may be used for transmitting and receiving signal to and from the wireless device 12 without the need for the RF switch 66. The microcontroller 60 is operably coupled to the transceiver 62 and the antenna 64 for transmitting and receiving signals to/from the wireless device 12 (e.g., the wireless signal 58) and the auxiliary base station 16. The microcontroller 60 determines the position of the wireless device 12 based on these signals. The main base station 14 further includes circuitry (not shown) for performing locking/unlocking of vehicle doors and/or a liftgate/trunk and for performing remote start operation.

The transceiver 62 is also generally configured to operate at a frequency of between 3 and 10 GHz and communicate within an ultra-wide band (UWB) bandwidth of at least 500 MHz. Operating the transceiver 62 at an operating frequency of between 3 and 10 GHz and within the UWB bandwidth may enable the main base station 14 to determine the distance of the wireless device 12 with respect to the vehicle within a high degree of accuracy when it engages in communication with the wireless device 12. The transceiver 62 generally includes an oscillator 74 and a PLL 76 for enabling the transceiver 62 to operate at the frequency of between 3 and 10 GHz.

The auxiliary base station 16 generally includes a microcontroller 80, a transceiver 82, and at least one antenna 84. An RF switch 86 is operably coupled to the microcontroller 80 and to the antenna 84. The RF switch 86 and the multi-antenna 84 implementation are optional for the reasons noted above. The microcontroller 80 is operably coupled to the transceiver 82 and the antenna 84 for transmitting and receiving signals to/from the wireless device 12 (e.g. the wireless signal 58) and the main base station 14. The power source 65 in the vehicle 18 powers the microcontroller 80 and the transceiver 82.

The transceiver 82 is also generally configured to operate at a frequency of between 3 and 10 GHz and communicate within an ultra-wide band (UWB) bandwidth of at least 500 MHz. Operating the transceiver 82 at an operating frequency of between 3 and 10 GHz enables the vehicle system 10 to determine the distance of the wireless device 12 with respect to the vehicle within a high degree of accuracy when it engages in communication with the wireless device 12. The transceiver 82 generally includes an oscillator 94 and a PLL 96 for enabling the transceiver 62 to operate at the frequency of between 3 and 10 GHz. It is recognized that the second and third auxiliary base stations 16b, 16n (shown in FIG. 1) are similar to the auxiliary base station 16 as described above and include similar components and provides similar functionality. In other embodiments, the vehicle system 10 includes simple auxiliary base stations 16 that only include the antennas 84, which are controlled by the microcontroller 60 of the main base station 14.

Each auxiliary base station 16 receives the wireless signal 58 from the wireless device 12, and transmits a message 98 to the main base station 14 that includes information that is indicative of an actual distance (D) between the base station 16 and the wireless device 12. The message 98 may include additional information, such as the acceleration data and the gyroscope data. The main base station 14 also receives the wireless signal 58 and generates a message (not shown) that includes information that is indicative of the actual distance between the main base station 14 and the wireless device 12. The auxiliary base stations 16 may communicate wirelessly with the main base station 14, or through a wired connection. In one embodiment the auxiliary base stations 16 communicate with the main base station 14 using a local interconnect network (LIN).

Because the wireless device 12, the main base station 14, and the auxiliary base stations 16 are each arranged to transmit and receive data within the UWB bandwidth of at least 500 MHz, this aspect may place large current consumption requirements on such devices. For example, by operating in the UWB bandwidth range, such a condition yields a large frequency spectrum (e.g., both low frequencies as well as high frequencies) and a high time resolution which improves ranging accuracy. Power consumption may not be an issue for the main base station 14 and the auxiliary base station 16 since such devices are powered from the power source 65 in the vehicle. However, this may be an issue for the wireless device 12 since it is a portable device. Generally, portable devices are equipped with a standalone battery. In the event the standalone battery is implemented in connection with the wireless device 12 that transmits/receives data in the UWB bandwidth range, and depending on the battery capacity and the specific circuitry in the wireless device 12, the battery may be depleted rather quickly. To account for this condition, the wireless device 12 may include the rechargeable battery 36 and the battery charger circuit 40, along with the charger connector 42 (or wireless charging implementation) such that the battery 36 can be recharged as needed to support the power demands used in connection with transmitting/receiving information in the UWB bandwidth range.

Existing PEPS systems (not shown) often include up to eight LF antennas that are located about the vehicle. The structure of the vehicle blocks the LF signals, therefore the antennas are mounted externally, or near windows to provide line of sight communication. Such systems often determine the location of the key fob based on a received signal strength (RSS) of a wireless signal.

The vehicle system 10 communicates at high frequency (e.g., 3-10 GHz) which allows for a reduced number of antennas as compared to existing systems. In general, the higher the operating frequency of the transceivers 32, 62, and 82; the larger the bandwidth that such transceivers 32, 62, and 82 can transmit and receive information. Such a large bandwidth (i.e., in the UWB bandwidth) may improve noise immunity and improve signal propagation. This may also improve the accuracy in determining the distance of the wireless device 12 since UWB bandwidth allows a more reliable signal transmission. As noted above, an operating frequency of 3-10 GHz enables the transceivers 32, 62, and 82 to transmit and receive data in the UWB range. The utilization of the UWB bandwidth for the wireless device 12, the main base station 14, and the auxiliary base stations 16 may provide for (i) the penetration of the transmitted signals to be received through obstacles (e.g., improved noise immunity), (ii) high ranging (or positioning) accuracy, (iii) high-speed data communications, and (iv) a low cost implementation. Due to the plurality of frequency components in the UWB spectrum, transmitted data may be received at the wireless device 12, the main base station 14, and the auxiliary base station 16 more reliably when compared to data that is transmitted in connection with a narrow band implementation (e.g., carrier frequency based transmission at 315 MHz, etc.). For example, UWB based signals may have both good reflection and transmission properties due to the plurality of frequency components associated therewith. Some of the frequency components may transmit through various objects while others may reflect well off of objects. These conditions may increase the reliability in the overall reception of data at the wireless device 12, the main base station 14, and the auxiliary base stations 16. Further, transmission in the UWB spectrum may provide for robust wireless performance against jamming. This may also provide for an anti-relay attack countermeasure and the proper resolution to measure within, for example, a few centimeters of resolution.

The implementation of UWB in the wireless device 12, the main base station 14, and the auxiliary base stations 16 is generally suitable for TOF applications. Although UWB based signals may have good reflection properties, the TOF calculations may become complicated if based on reflected signals. Therefore the base stations 14, 16 may be mounted within the passenger compartment and near windows or the windshield (e.g., within the headliner or dashboard) to allow for generally line of sight communication with the wireless device 12.

The vehicle system 10 determines a position (x, y, z) of the wireless device 12 relative to the vehicle. The wireless device 12 and the base stations 14, 16 are continuously communicating with each other. Each base station 14, 16 determines a distance between itself and the wireless device 12 using TOF, and sends this actual distance data to the main base station 14, according to one embodiment. In other embodiments, only the auxiliary base stations 16 determine a distance between themselves and the wireless device 12 using TOF and then send this actual distance data to the main base station 14. The main base station 14 analyzes the actual distance data and then filters the actual distance data using a Kalman filtering algorithm to estimate a current position (x, y, z) of the wireless device 12, and a future position (xₜ₊₁, yₜ₊₁, zₜ₊₁) of the wireless device 12.

With reference to FIG. 3, the vehicle system 10 defines a plurality of coverage zones 20 about the vehicle 18. As described above with reference to FIG. 1, the vehicle system 10 defines zones 20 about each entry position of the vehicle 18 (“entry zones”), e.g., within two meters of each door. For example, the illustrated embodiment depicts a driver side zone 20a, a passenger side zone 20b and a vehicle rear zone 20c. The vehicle system 10 also defines zones within the vehicle 18 (“internal zones”), such as a storage compartment zone 20d, and a passenger compartment zone 20e. The vehicle system 10 also defines zones based on a distance from the vehicle 18 (“external zones”). As shown in the illustrated embodiment, the vehicle system 10 defines a far zone 20f, as a region beyond approximately ten meters from the center of the vehicle 18; a proximate zone 20g, as a region within approximately five meters from an outer perimeter of the vehicle 18; and an intermediate zone 20h, as a region between 20f and 20g. Thus, the vehicle system 10 includes entry zones (20a, 20b, and 20c), internal zones (20d, and 20e), and external zones (20f, 20g, and 20h). The size and shape of the zones 20 may vary between each application of the vehicle system 10.

The vehicle system 10 estimates the position of the wireless device 12 in two-dimensional (“2D”) space, e.g., (x, y) or in three-dimensional (“3D”) space (x, y, z) depending on which zone 20 the wireless device 12 is located in. Although position estimations in the 3D space are generally more accurate, they are also susceptible to error if there are any obstacles between the base station 14, 16 and the wireless device 12. Therefore, the vehicle system 10 estimates a 2D position (x,y) of the wireless device 12 when the wireless device 12 is located in the external zones (20f, 20g, and 20h); and estimates a 3D position (x, y, z) of the wireless device 12 when it is located in the entry or internal zones (20a-20e).

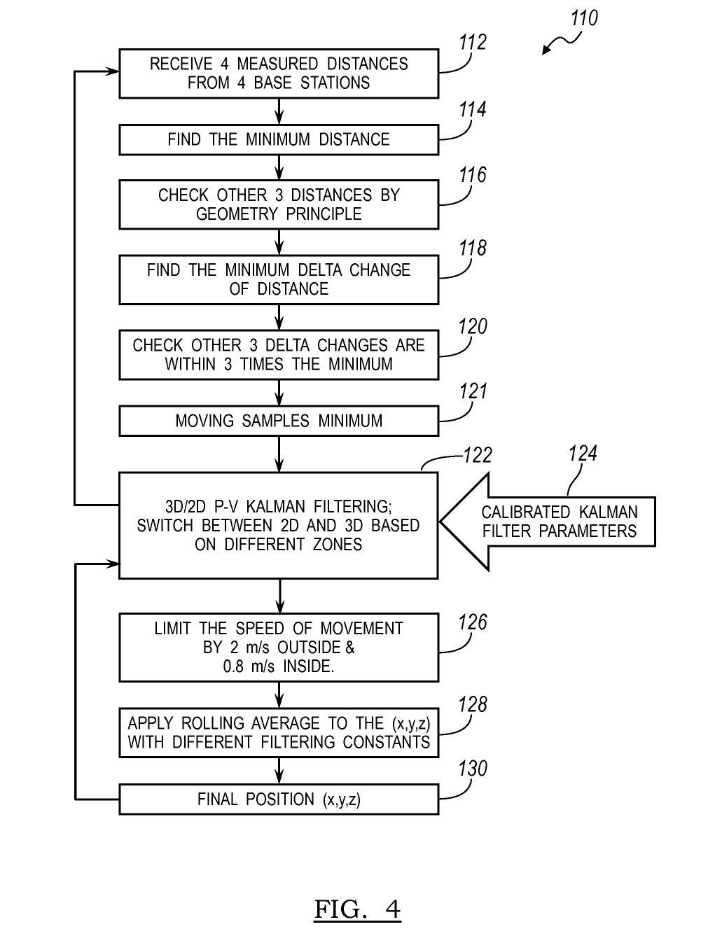

With reference to FIG. 4, a method for estimating a position of the wireless device is illustrated in accordance with one or more embodiments and is generally represented by numeral 110. The method 110 is implemented using software code contained within the microcontroller of the main base station according to one or more embodiments. In other embodiments the software code is shared between multiple controllers or microcontrollers.

At step 112, the main base station 14 receives the actual distance information from each of the auxiliary base stations 16. At step 114, the main base station 14 analyzes the actual distance information to find the minimum distance.

At step 116, the main base station 14 analyzes the actual distance information using a geometry principle. Because the location of each base station is fixed, the distances between each base station 14, 16 and the wireless device 12 are related by a geometry principle. For example, the distance from the wireless device 12 to the first auxiliary base station 16a cannot be longer than the sum of the distance from the wireless device 12 to the second auxiliary base station 16b and the distance between the first auxiliary base station 16a and the second auxiliary base station 16b. From the four distances, first the main base station 14 determines which actual distance is the least, then checks the other distances using the above principle to see if the distance is reasonable or not. If not, the main base station 14 simply disregards the data.

At step 118, the main base station 14 determines a change (AD) in the actual distance data between the current data (Dₜ), and previous data (Dₜ₋₁), for each base station. The main base station 14 then determines which (ΔD) is the lowest (ΔDₘᵢₙ).

At step 120, the main base station 14 determines a threshold value (ΔLimit) based on ΔDₘᵢₙ. In one embodiment, ΔLimit is equal to three times ΔDₘᵢₙ. Then, the main base station 14 removes any actual distance data (Dₜ) whose AD is greater than ΔLimit.

At step 121, the main base station 14 analyzes the data using a “moving samples minimum” strategy. The main base station 14 saves the last five distance values from each auxiliary base station 16. As new data is received, the oldest of the five previously saved distance values is removed and the main base station 14 compares the last five samples for each auxiliary base station 16 (i.e., “moving samples”).

At step 122, the main base station 14 estimates a current position (P) of the wireless device 12 using the actual distance (D) data and calibrated Kalman filter parameters 124. The main base station 14 estimates P in 2D space (x,y) when the wireless device 12 is located in the external zones (20f, 20g and 20h), and estimates P in 3D space (x, y, z) when the wireless device 12 is located in the entry or internal zones (20a-20e).

In one embodiment, the main base station 14 uses a position and velocity (“PV”) model Kalman filter to recursively determine the position of the wireless device 12 from the distance information. The basic idea of 3D Kalman filtering is as follows, first the main base station 14 starts with a predicted position of the wireless device 12 (x,y,z). Then the main base station 14 calculates the predicted distances to the four base stations with known positions (ax,ay,az), (bx, by, bz), (cx,cy,cz), and (dx,dy,dz). The following equations illustrate this calculation:

a=sqrt((x−ax)̂2+(y−ay)̂2+(z−az)̂2)

b=sqrt((x−bx)̂2+(y−by)̂2+(z−bz)̂2)

c=sqrt((x−cx)̂2+(y−cy)̂2+(z−cz)̂2)

d=sqrt((x−dx)̂2+(y−dy)̂2+(z−dz)̂2)

The Kalman filter compares these estimated distances with the actual distances that were provided by the base stations to determine how much to adjust to the estimated position (x,y,z). Then the updated position is again used in calculation and compared to new upcoming measured distances. This recursive process is continuously progressing as new measured data is continuously provided by the base stations, and the Kalman filter is continuously predicting the new position of the wireless device 12. For estimating the position in 2D space using the Kalman filter, the main base station 14 removes the z axis data, making the z terms in the above equations to zero.

At step 126, the main base station 14 limits the velocity of the wireless device 12 to a threshold value based on its location. For example, in one embodiment the threshold value is equal to 0.8 m/s when the wireless device 12 is located within the vehicle (e.g., zones 20d and 20e), and the threshold value is equal to 2.0 m/s when the wireless device 12 is located outside of the vehicle (e.g., zones 20a-20c, and 20f-20h).

At step 128, the main base station 14 filters the estimated position (P) of the wireless device 12 using a rolling average. The rolling average includes different filtering constants (fk) depending on the location of the wireless device 12. For example, for position (x), the main base station 14 uses the following equation:

New x output=(1−fk)*current x+fk*last x

Where fk=0.8 when it is determined that the wireless device 12 is located inside of the vehicle cabin (e.g., zone 20e), which means that fk is heavily filtered and the current x calculated from the Kalman filter only contributes 20% to the final output; and fk=0.2 when it is determined that the wireless device 12 is located outside of the vehicle, i.e., it is lightly filtered, so the methodology allows for greater movement when the wireless device 12 is located outside of the vehicle.

At step 130, the main base station 14 determines a final position (P) of the wireless device 12.

As such the vehicle system 10 estimates the position of the wireless device using Kalman filters in the 2D and 3D space depending on the location of the wireless device 12 from the vehicle. By using estimations in both 2D and 3D, the vehicle system 10 provides an accurate position determination.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle system comprising:
a portable device configured to provide a wireless signal;
at least three base stations for being positioned about a vehicle, each base station being configured to receive the wireless signal and to generate a message indicative of a time of flight of the wireless signal; and
a main base station for being positioned within the vehicle and configured to determine a general location of the portable device within one of a plurality of zones about the vehicle and to determine a three-dimensional location of the portable device based on the message using a first estimation in response to the portable device being located in a first zone.

2. The vehicle system of claim 1 wherein the main base station is further configured to determine a two-dimensional location of the portable device using a second estimation in response to the portable device being located in a second zone.

3. The vehicle system of claim 1 wherein the first zone corresponds to location within at least one of a vehicle cabin and a vehicle entry area.

4. The vehicle system of claim 1 wherein the message generated by each of the at least three bases stations is indicative of a distance from the portable device, wherein the at least three base stations comprise a first base station, a second base station and a third base station, and wherein the main base station is further configured to:
receive a first message indicative of a first distance between the portable device and the first base station;
receive a second message indicative of a second distance between the portable device and the second base station;
receive a third message indicative of a third distance between the portable device and the third base station; and
estimate the three-dimensional location of the portable device based on the first distance, the second distance and the third distance.

5. The vehicle system of claim 4 wherein the main base station is further configured to remove the first distance from the first estimation of the three-dimensional location of the portable device in response to the first distance being greater than a sum of the second distance and a base station distance between the first base station and the second base station.

6. The vehicle system of claim 4 wherein the main base station is further configured to determine a difference between a current first distance and a previous first distance and to remove the current first distance from the first estimation of the three-dimensional location of the portable device in response to the difference being greater than a threshold value.

7. The vehicle system of claim 4 wherein the main base station is further configured to:
receive the wireless signal;
determine a fourth distance between the portable device and the main base station based on the time of flight of the wireless signal; and
estimate the three-dimensional location of the portable device based on the first distance, the second distance, the third distance and the fourth distance.

8. The vehicle system of claim 1 wherein the main base station is further configured to filter the three-dimensional location of the portable device using a rolling average.

9. The vehicle system of claim 1 wherein the at least three base stations are positioned proximate to a roof of the vehicle and the main base station is offset vertically from the at least three base stations.

10. A vehicle system comprising:
at least two base stations for being positioned about a vehicle, each base station being configured to receive a wireless signal from a portable device and to generate a message indicative of a time of flight of the wireless signal; and
a main base station for being positioned within the vehicle and configured to determine a general location of the portable device within one of a plurality of zones about the vehicle and to determine a three-dimensional location of the portable device based on the message using a first estimation in response to the portable device being located in a first zone.

11. The vehicle system of claim 10 wherein the at least two base stations comprise a first base station and a second base station, and wherein the main base station is further configured to:
receive a first message indicative of a first distance between the portable device and the first base station;
receive a second message indicative of a second distance between the portable device and the second base station;
estimate the three-dimensional location of the portable device based on the first distance and the second distance.

12. The vehicle system of claim 11 wherein the main base station is further configured to remove the first distance from the first estimation of the three-dimensional location of the portable device in response to the first distance being greater than a sum of the second distance and a base station distance between the first base station and the second base station.

13. The vehicle system of claim 11 wherein the main base station is further configured to determine a difference between a current first distance and a previous first distance and to remove a the current first distance from the first estimation of the three-dimensional location of the portable device in response to the current first distance being greater than a threshold value.

14. The vehicle system of claim 10 wherein the main base station is further configured to determine a two-dimensional location of the portable device using a second estimation in response to the portable device being located in a second zone.

15. The vehicle system of claim 10 wherein the first zone corresponds to location within at least one of a vehicle cabin and a vehicle entry area.

16. A vehicle system comprising:
a portable device configured to provide a wireless signal;
at least two base stations for being positioned about a vehicle, each base station being configured to receive the wireless signal and to generate a message indicative of a time of flight of the wireless signal; and
a main base station for being positioned within the vehicle and configured to:
determine a general location of the portable device within one of a plurality of zones about the vehicle;
determine a location of the portable device based on the message using a first estimation in response to the portable device being located in a first zone within the vehicle; and
determine the location of the portable device using a second estimation in response to the portable device being located in a second zone.

17. The vehicle system of claim 16 wherein the at least two base stations comprise a first base station and a second base station, and wherein the main base station is further configured to:
receive a first message indicative of a first distance between the portable device and the first base station;
receive a second message indicative of a second distance between the portable device and the second base station;
determine the location of the portable device based on the first distance and the second distance.

18. The vehicle system of claim 17 wherein the main base station is further configured to remove the first distance from the determination of the location of the portable device in response to the first distance being greater than a sum of the second distance and a base station distance between the first base station and the second base station.

19. The vehicle system of claim 17 wherein the main base station is further configured to determine a difference between a current first distance and a previous first distance and to remove the current first distance from the determination of the location of the portable device in response to the current first distance being greater than a threshold value.

20. The vehicle system of claim 16 wherein the main base station is further configured to filter the location of the portable device using a rolling average.
